(19) United States
(12) Patent Application Publication
(10) Pub. No.: US 2009/0301834 A1
(43) Pub. Date: Dec. 10, 2009

(54) Electric Vehicle and Associated Transport System

(75) Inventors: Pierre-Jean Vienney, Paris (FR); Yann Chaintron, Vitrolles (FR)

Correspondence Address: Davidson, Davidson & Kappel, LLC, 485 7th Avenue, 14th Floor, New York, NY, 10018, US

(73) Assignee: ALSTOM TRANSPORT SA, Levallois-Perret (FR)

(21) Appl. No.: 12/352,343

(22) Filed: Jan. 12, 2009

(30) Foreign Application Priority Data
Jan. 11, 2008 (FR) 08 50158

(51) Int. Cl. B60M 1/10

(52) U.S. Cl. 191/18

(57) ABSTRACT

An electric vehicle is provided including an electric drive, at least one first electric power collecting shoe to power the drive, and at least one first transmitter. The first collecting shoe is separated from the first transmitter by a first distance greater than 0.2 meters, the first transmitter is positioned in front of the first collecting shoe in the direction of travel of the vehicle. The invention also provides an associated transport system.

This document claims priority to FR 08 50158 filed on Jan. 11, 2008, hereby incorporated by reference herein.

The present invention relates to an electric vehicle adapted to travel in a given direction of travel, the vehicle being capable of being powered by a supply device in the ground.

### BACKGROUND OF THE INVENTION

The document EP 1 043 187, in particular, discloses a transport system comprising a series of supply track segments which are flush with the crossing surface and a series of control devices which are each adapted to selectively connect a track segment to a power supply line or to a running rail potential protection line, depending on whether or not the control device is receiving an electromagnetic signal generated by a transmitter located in an electric vehicle moving on the crossing.

The electric vehicle comprises an electric motor, two collecting shoes placed in contact with the track segments to power the motor, and two transmission coils surrounding the shoes. The transmission coils are adapted to generate an electromagnetic signal in the direction of the control device.

### SUMMARY OF THE INVENTION

An object of the present invention provides an alternative electric vehicle.

A further additional or alternative object of the invention provides an alternative transport system.

The present invention provides an electric vehicle adapted to travel in a given direction of travel; the vehicle being capable of being powered by a supply device in the ground, the supply device in the ground comprising a power supply line, conductive track segments and control means, each coupled to a track segment, each control means being adapted to detect an electromagnetic signal transmitted by a detector and to connect the power supply line to the track segment which is coupled thereto, when it detects said electromagnetic signal, the vehicle including:

electric drive means;

at least one first collecting shoe adapted to come into contact with each track segment in succession, to power the drive means,

at least one first transmitter capable of transmitting an electromagnetic signal in the direction of each control means, characterized in that the first collecting shoe is separated from the first transmitter by a first distance greater than 0.2 meter, and in that the first transmitter is positioned in front of the first collecting shoe in the direction of travel of the vehicle.

According to other preferred embodiments, the electric vehicle may include one or more of the following features:
the electric vehicle further comprises a second collecting shoe and a second transmitter, the second collecting shoe is separated from the second transmitter by a second distance, and the second transmitter is positioned behind the second collecting shoe in the direction of travel of the vehicle;
the electric vehicle further comprises a third transmitter, separated and positioned behind the second collecting shoe in the direction of travel of the vehicle;
the electric vehicle further comprises a fourth transmitter, separated and positioned in front of the first collecting shoe in the direction of travel of the vehicle, the fourth transmitter being separated from the second collecting shoe by the same distance;
the first distance and the second distance are each between 0.2 meter and 3 meters; and
the electric vehicle further comprises a guiding unit capable of stopping a transmitter selected from the third transmitter and the fourth transmitter, the selected transmitter being located at the back of the electric vehicle in the direction of travel of the vehicle.

The present invention also provides a transport system comprising:
a supply device in the ground comprising a power supply line and conductive track segments, which are positioned one behind the other and insulated from one another;
control means, each comprising a detection means and a switching means, which are coupled to the same track segment, the detection means extending parallel to the track segment, which is coupled thereto, at least a portion of the detection means protruding relative to this track segment, the detection means being capable of detecting an electromagnetic signal transmitted by a transmitter; the switching means being adapted to connect the power supply line to the track segment, which is coupled thereto, when the detection means detects said electromagnetic signal; characterized in that it comprises an electric vehicle according to the invention and in that said first distance and second distance are less than the length of the portion or each portion of the detection means protruding relative to the track segment.

According to other preferred embodiments, the transport system may include one or more of the following features:
the supply device in the ground comprises a protection line connected to the running rail, each switching means being adapted to connect the protection line to the track segment, which is coupled thereto, when the detection means does not detect an electromagnetic signal, and each control device comprises a monitoring device capable of interrupting a safety line to cause the supply device in the ground to trip when the detection means does not detect an electromagnetic signal after a predefined period and the switching means is still connected to the track segment after said predefined period;
each track segment has a length of between 4.02 and 18 meters;
each detection means extends over a length of between 6.02 and 24 meters.
two adjacent detection means are contiguous and the track segments are separated from one another by a gap; and
each detection means comprises a detection loop surrounding a track segment.

### BRIEF DESCRIPTION OF THE DRAWINGS

The invention will be understood better on reading the following description which is given merely as an example with reference to the drawings in which:

FIG. 1 is a schematic side view of a first embodiment of the transport system according to the invention and an electric vehicle according to the invention; and

FIG. 2 is a schematic side view of a second embodiment of the transport system according to the invention and an electric vehicle according to the invention.

### DETAILED DESCRIPTION OF PREFERRED EMBODIMENTS

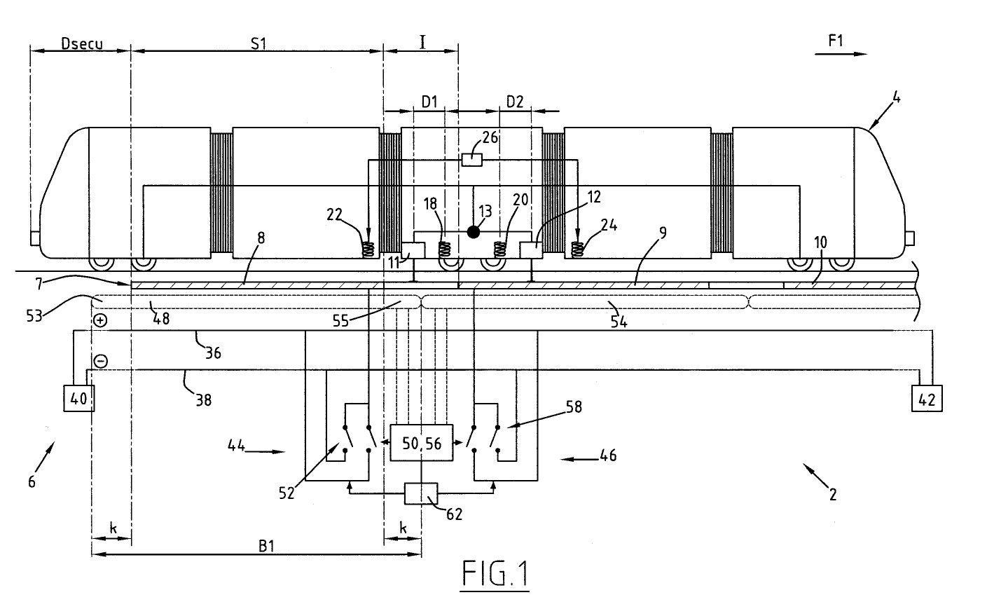

FIG. 1 shows a transport system 2 according to a first embodiment of the present invention. It comprises an electric vehicle 4 according to the invention which is adapted to be powered by a supply system in the ground 6.

The supply system in the ground 6 comprises a supply track 7 formed by a series of conductive track segments 8, 9, 10.

The track segments 8, 9, 10 are positioned one behind the other along the crossover and are separated from one another by an insulating zone I extending over approximately 2 to 6 meters. This insulating zone prevents the passage of current from one track segment to another.

According to the first embodiment of the invention, the track segments 8, 9, 10 have a length S1 of between 4 and 15 meters, depending on the length of the vehicle in question.

According to the invention, the electric vehicle 4 has a length which is approximately equal to the length of three successive track segments 8, 9, 10. In particular, the electric vehicle 4 has a length greater than 20 meters. The electric vehicle 4 allows current to return through the wheels which are electrically connected to the metal running rails.

The electric vehicle 4 is equipped with a first collecting shoe 11, a second collecting shoe 12 and an electric motor 13 electrically connected to the collecting shoes 11 and 12.

The collecting shoes 11 and 12 are adapted to come into contact in succession with the track segments 8, 9, 10 to power the electric motor 13.

The collecting shoes 11 and 12 are fixed in a central portion of the electric vehicle 4. They are separated by a distance greater than the length of the insulating zone I so that a collecting shoe 11 always remains in contact with a track segment 8, 9, 10 when the other collecting shoe 12 is positioned between two track segments. The electric vehicle 4 is therefore always supplied with power.

The track segments 8, 9, 10 are flush with the surface of the crossover so the collecting shoes 11, 12 are adapted to come to the contacts thereof.

The electric vehicle 4 is also equipped with a first transmitter 18, a second transmitter 20, a third transmitter 22, and finally a fourth transmitter 24 which are controlled by a guiding unit 26. In this document, the transmitters and shoes are qualified as the first, second, third and fourth, depending on their importance to the invention and not their geographical position relative to the direction of travel F1 of the vehicle 4. The fourth emitter 24 is thus positioned at the front of the vehicle 4 when the vehicle travels in the direction F1. It is followed by the second shoe 12, then by the second transmitter 20, the first transmitter 18, the first shoe 11 and finally the third transmitter 22.

Each transmitter 18, 20, 22, 24 consists of a transmission coil adapted to generate an electromagnetic signal in the direction of the supply system in the ground 6.

According to the invention, the first transmitter 18 is positioned in front of and at a distance from the first collecting shoe 11 in the direction of travel F1. In particular, a first distance D1 separates the first transmitter 18 from the first collecting shoe 11.

The second transmitter 20 is positioned behind and at a distance from the second collecting shoe 12 in the direction of travel F1. In particular, a second distance D2 separates the second transmitter 20 from the second collecting shoe 12.

The first distance D1 and second distance D2 are generally between 0.2 and 3 meters. These distances D1 and D2 are measured in a horizontal plane, in other words, these distances do not take into consideration the height at which the transmitters and collecting shoes are fixed to the chassis.

In the embodiment of the invention illustrated in FIG. 1, the first distance D1 is of substantially the same length as the second distance D2. In a variation, the first distance and second distance may be of different lengths.

The third transmitter 22 is positioned behind and at a distance from the first collecting shoe 11, still in the direction of travel F1.

The fourth transmitter 24 is positioned in front of and at a distance from the second collecting shoe 12, still in the direction of travel F1.

The guiding unit 26 is adapted to control the starting and stopping of the third transmitter 22 or the fourth transmitter 24 as a function of the direction of travel of the vehicle, as explained in the remainder of the description.

The supply system in the ground 6 further comprises a power supply line 36, a protection line 38 and control means 44, 46, for example, controllers, each capable of connecting a track segment 8, 9, 10 to the power supply line 36 or to the protection line 38 brought to the potential of the running rail.

The supply line 36 and protection line 38 extend along the track segments 8, 9, 10 and are permanently connected to two supply substations 40 and 42. The power supply line 36 is continuously kept at a voltage of 750 volts.

The control means 44 comprises a detector including, for example, detection loop 48 which is coupled to the track segment 8 and surrounds this track segment 8, a control unit 50 connected to the detection loop 48 and a switching means 52, for example, a switch, controlled by the control unit 50.

The detection loop 48 is adapted to detect an electromagnetic signal transmitted by a transmitter 18, 20, 22, 24 only when this transmitter is located above and opposite the detection loop 48.

The detection loop 48 extends parallel to the track segment 8 over a length B1 which is greater than the length S1 of the track segment 8. A portion 53, 55 of the detection loop 48 protrudes beyond each end of the track segment 8. Each portion 53, 55 of the detection loop protruding beyond the track segment 8 has a length k of between 0 meter and I/2 meters (I being the length of the insulating zone).

The portion 53 of the detection loop detects the presence of the transmitter 18, 20, 22, 24 before the collecting shoe 11 or 12 touches the track segment 8, 9 or 10, thus allowing said live track segment to be switched off.

The length of B1 is therefore comprised between 6 and 21 meters. In the first embodiment of the invention illustrated in FIG. 1, in particular, each detection loop 48, 54 has a length B1 of approximately 11 meters.

According to the invention, the first distance D1 defined between the first collecting shoe 11 and the first transmitter 18, as well as the second distance D2 defined between the second collecting shoe 12 and the second transmitter 20 are each less than the length k of the portions 53, 55 by which the detection loop 48 protrudes relative to the track segment 8.

The control unit 50 is adapted to receive the electromagnetic signal detected by the detection loop 48 and to detect the absence of such an electromagnetic signal. The control unit 50 is also capable of controlling the switching means 52 as a function of the presence or the absence of this electromagnetic signal.

The switching means 52 is adapted to connect the track segment 8 to the supply line 36 when the control unit 50 detects the presence of an electromagnetic signal and to connect this same track segment 8 to the protection return line 38 when the control unit 50 does not detect an electromagnetic signal.

The control means 44 is therefore adapted to connect the track segment 8 to the supply line 36 when the control unit 50 detects a signal originating from a transmitter 18, 20, 22, 24. This signal is normally received when one of the transmitters transmits an electromagnetic signal and is located on the detection loop 48. The control means 44 is also adapted to connect the track segment 8 to the protection line 38 when the control unit 50 does not detect a signal originating from a transmitter; in other words, when no transmitter 18, 20, 22, 24 is located above this detection loop 48.

The control means 46 is coupled to the following track segment designated 9. It is identical to the control means 44.

Control means 46 comprises a detector, including for example, detection loop 54 coupled to the track segment 9, a control unit 56 connected to the detection loop 54 and a switching means 58, for example, a switch, controlled by the control unit 56.

The detection loop 54 is adjacent and contiguous to the detection loop 48.

The control units 50 and 56 have been shown schematically by a single box in FIG. 1 as they are generally fitted in the same box.

The control means 46 is adapted to connect the track segment 9 to the supply line 36 when a transmitter 18, 20, 22, 24 transmitting an electromagnetic signal is disposed above the detection loop 54 and to connect the track segment 9 to the protection line 38 when this transmitter 18, 20, 22, 24 is not located above the detection loop 54.

The supply system in the ground 6 further comprises a monitoring device 62 adapted to interrupt the safety line connecting the equipment 44 and 46 to the supply substations 40 and 42. This interruption causes the two supply substations 40 and 42 to trip if, after a predefined period Tp, one of the detection loops 48, 54 does not detect an electromagnetic signal and the track segment 8, 9 which is coupled thereto has not been put back into contact with the protection line 38.

The monitoring device 62 is accordingly adapted to monitor the state of connection of the switching means 52, 58 and to compare this state to the information as to whether or not the electromagnetic signal is detected by the detection loops 48, 54. This information is transmitted to them by the control units 50, 56.

In a variation, the adjacent detection loops 48 and 54 are not contiguous. They are separated, for example, by a distance of a few meters.

In operation, during displacement of the vehicle 4 in the direction F1, the guiding unit 26 controls the first transmitter 18, the second transmitter 20 and the fourth transmitter 24 so they transmit an electromagnetic signal. In addition, the guiding unit 26 controls the third transmitter 22 which is then located at the back of the train, so it does not transmit an electromagnetic signal.

When the fourth transmitter 24 of the electric vehicle arrives on the portion 53 of the detection loop 48 protruding relative to the track segment 8, the electromagnetic signal transmitted thereby is detected by the detection loop 48. The control unit 50 receives this signal and controls the switching means 52 so that it connects the track segment 8 to the supply line 36 to power it. The second collecting shoe 12 picks up current via the track segment 8 and powers the motor 13.

As the track segment 8 is powered before the second collecting shoe 12 reaches it, the motor 13 of the electric vehicle does not call for current during the switching of the equipment 52, so a very big and heavy switching means 52 is not required.

When the fourth transmitter 24 arrives above the following detection loop 54, the detection loop 54 detects the electromagnetic signal transmitted by the fourth transmitter 24, and the control unit 56 controls the switching means 58 so that it connects the following track segment 9 to the power supply line 36. At this moment, the preceding track segment 8 is still powered because the first transmitter 18 is still located above the reception loop 48, and this allows the motor 13 to be powered through the first collecting shoe 11 which is still in electrical contact with the first track segment 8.

When the first transmitter 18 is not opposite the receiving loop 48, the control unit 50 guides the switching means 52 so that it connects the track segment 8 to the protection line 38.

At this moment, the back of the vehicle 4 is at a predefined distance Dsecu from the nearest end of the track segment 8 (left-hand portion in FIG. 1).

At this moment, the system has a time Tsecu before the track segment 8 appears at the back of the vehicle 4. This time Tsecu is broken down into Tsecu1+Tsecu2. The control unit 50 and the switching means 52 have a time Tsecu1 to disconnect the track segment 8 from the power supply line 38 and connect it to the protection line 38. If this has not been achieved by the end of time Tsecu1, this dysfunction is detected by the control unit 50, and the supply substations 40 and 42 have Tsecu2 to disconnect the supply line 36.

This total time Tsecu must be equal to or less than the time required for the electric vehicle to cover the distance Dsecu defined between the back of the vehicle and the closest end of the track segment 8 (left-hand end of the track segment 8 in FIG. 1) to prevent the possible electrocution of a pedestrian located on the track segment 8.

As the first transmitter 18 is positioned in front of the first collecting shoe 11, the distance Dsecu is greater in the electric vehicle 4 according to invention than in a vehicle from the prior art in which, on the one hand, the transmitters 18 and 20 are disposed round the first collecting shoe 11 and the second collecting shoe 12 and, on the other hand, the transmitters 22 and 24 do not exist.

In particular, as the first transmitter 18 is separated from the first collecting shoe 11 by a first distance D1, the distance Dsecu in the transport system 2 according to the invention is equal to the distance Dsecu of an electric vehicle from the prior art plus the first distance D1.

When the electric vehicle travels in the opposite direction to the direction F1, the guiding unit 26 stops the transmitter 24 which is now located at the back of the vehicle.

Consequently, the electric vehicle 4 according to the invention comprises two more transmitters 22, 24 than electric vehicles from the prior art, so it may be able to run more quickly without sacrificing safety, or longer segments 8, 9, 10 can be installed without sacrificing safety.

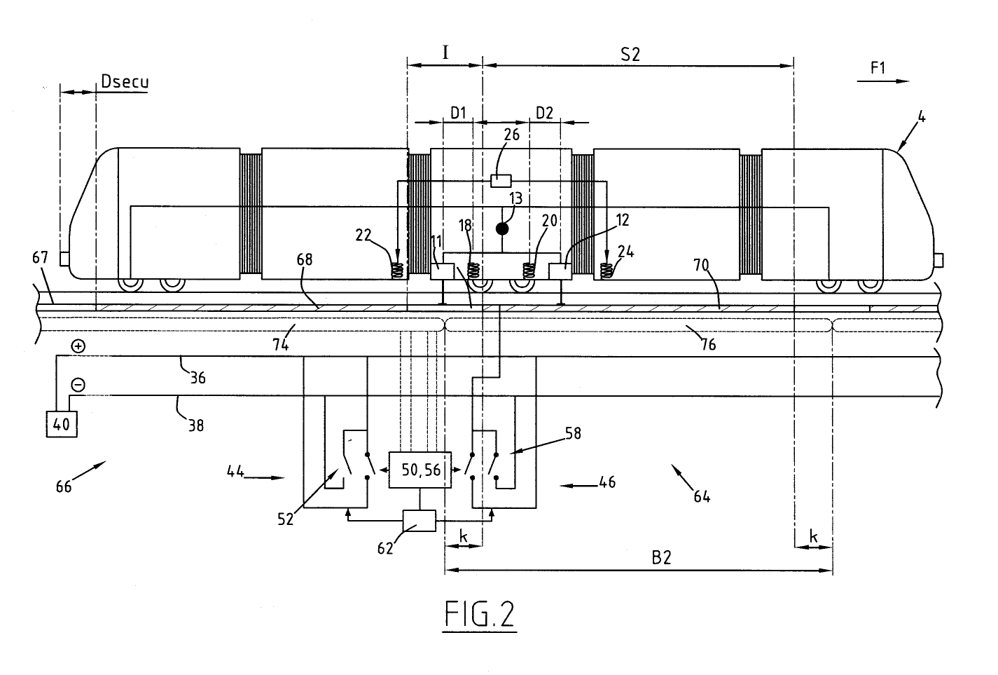

FIG. 2 shows a transport system 64 according to a second embodiment of the invention. Referring to FIG. 2, components identical to the components of FIG. 1 have been given like reference numerals and will not be described again.

The transport system 64 comprises an electric vehicle 4 identical to the electric vehicle 4 shown in FIG. 1, and a supply system in the ground 66 capable of powering this vehicle.

The supply system in the ground 66 comprises a supply track 67 formed by a series of conductive track segments 68, 70 and a series of detection loops 74, 76, each surrounding a track segment 68, 70.

The track segments 68, 70 of the second embodiment of the invention have a length S2 which is greater than the length S1 of the track segments 8, 9, 10 of the first embodiment of the invention.

In particular, the track segments 68, 70 have a length S2 which is equal to the length S1 plus the smallest distance between the first distance D1 and the second distance D2. This smallest distance is hereinafter denoted D. In the example described above, the distance D1=D2=D, and is between 0.2 and 3 meters.

Consequently, the track segments 68, 70 have a length of from 4.2 meters (=4+0.2) to 18 meters (=15+3).

Similarly, the detection loops 74 and 76 of the second embodiment of the invention have a length B2 which is greater than the length B1 of the detection loops 48, 54 of the first embodiment of the invention.

In particular, the detection loops 74 and 76 have a length B2 which is equal to the length B1 of the detection loop 48, 54 of the first embodiment of the invention plus the distance D.

For example, the detection loops 74 and 76 have a length of from 6.02 meters (=4.02+2) to 24 meters (=18+6).

The transport system 64 operates in the same way as the transport system 6.

The safety distance Dsecu of the transport system 64 is equal to the distance Dsecu of the prior art but the transport system 64 comprises fewer boxes 50, 56 for a given length of supply track 67.

As shown in FIGS. 1 and 2, a box 50, 56 is disposed along the crossover to control the supply of a supply track 7 having a length of B1+B1 in the supply system 6 according to the first embodiment of the invention whereas a box 50, 56 is used to control the supply of a supply track 67 extending over a length of B2+B2=B1+B1+D+D in the supply system 66.

Therefore, the transport system 64 according to this second embodiment of the invention may be more economical as it allows fewer boxes 50, 56 to be installed over a predefined length of supply track.

The first and second embodiments of the invention can be used independently of one another or in combination.

Advantageously, as the transmitters 18, 20, 22, 24 are remote from the collecting shoes 11, 12, the live shoes do not modify the electromagnetic signal transmitted by the transmitters.

What is claimed is:

1-12. (canceled)

13. An electric vehicle adapted to travel in a given direction of travel, the vehicle capable of being powered by a supply device in the ground, the supply device in the ground including a power supply line, conductive track segments and a plurality of controllers, each coupled to a track segment, each controller being adapted to detect an electromagnetic signal transmitted by a transmitter and to connect the power supply line to the track segment coupled thereto when the controller detects the electromagnetic signal, the vehicle comprising:
an electric drive;
at least one first collecting shoe adapted to come into contact with each track segment in succession, to power the drive;
at least one first transmitter capable of transmitting an electromagnetic signal in the direction of each controller, the first collecting shoe being separated from the first transmitter by a first distance greater than 0.2 meters, the first transmitter being positioned in front of the first collecting shoe in the direction of travel of the vehicle.

14. The electric vehicle according to claim 13 further comprising a second collecting shoe and a second transmitter, the second collecting shoe being separated from the second transmitter by a second distance, the second transmitter being positioned behind the second collecting shoe in the direction of travel of the vehicle.

15. The electric vehicle according to claim 14 further comprising a third transmitter separated and positioned behind the second collecting shoe in the direction of travel of the vehicle.

16. The electric vehicle according to claim 14 further comprising a fourth transmitter separated and positioned in front of the first collecting shoe in the direction of travel of the vehicle, the fourth transmitter being separated from the second collecting shoe by the first distance.

17. The electric vehicle according to claim 14 wherein the first distance and the second distance are each between 0.2 meters and 3 meters.

18. The electric vehicle according claim 16 further comprising a guiding unit capable of stopping the third transmitter or the fourth transmitter, the third transmitter or fourth transmitter being located at the back of the electric vehicle in the direction of travel of the vehicle.

19. A transport system comprising:
a supply device in the ground including a power supply line and conductive track segments, the track segments being positioned one behind the other and insulated from one another;
a plurality of controllers each including a detector and a switch which are coupled to a same track segment; the detectors extending parallel to the track segment,
at least a portion of the detectors protruding relative to the track segment, the detectors capable of detecting an electromagnetic signal transmitted by a transmitter,
the switches being adapted to connect the power supply line to the track segment when the detectors detect the electromagnetic signal, and
an electric vehicle including:
an electric drive;
at least one first collecting shoe adapted to come into contact with each track segment in succession, to power the drive;
a first transmitter capable of transmitting an electromagnetic signal in the direction of each controller, the first collecting shoe being separated from the first transmitter by a first distance greater than 0.2 meters, the first transmitter being positioned in front of the first collecting shoe in the direction of travel of the vehicle, and
a second collecting shoe and a second transmitter, the second collecting shoe being separated from the second transmitter by a second distance, the second transmitter being positioned behind the second collecting shoe in the direction of travel of the vehicle,
the first distance and second distance being less than a length of a portion or each portion of the detectors protruding relative to the track segment.

20. The transport system according to claim 19 wherein the supply device in the ground includes a protection line connected to a running rail,
each switch being adapted to connect the protection line to the track segment when the detectors do not detect an electromagnetic signal,
each supply device comprising a monitoring device capable of interrupting a safety line to cause the supply device in the ground to trip when the detectors do not detect an electromagnetic signal after a predefined period and each switch is still connected to the track segment after said predefined period.

21. The transport system according to claim 19 wherein each track segment has a length between 4.02 and 18 meters.

22. The transport system according to claim 19 wherein the detectors extend over a length between 6.02 and 24 meters.

23. The transport system according to claim 19 wherein in the detectors are adjacent and contiguous and the track segments are separated from one another by a gap.

24. The transport system according to claim 19 wherein each detector includes a detection loop surrounding a track segment.
